(19) United States
(12) Patent Application Publication
(10) Pub. No.: US 2008/0281642 A1
(43) Pub. Date: Nov. 13, 2008

(54) Business method for insurance, warranty or mutual company coverage on concrete, asphalt, brick, stucco, block and stone

(75) Inventor: Steven Michael Zimmerman, Overland Park, KS (US)

Correspondence Address: STEVEN M. ZIMMERMAN, 5833 NEWTON ST., OVERLAND PARK, KS, 66202-2260, US

(73) Assignee: Marcia Denise Zimmerman, Overland Park, KS (US)

(21) Appl. No.: 12/151,525

(22) Filed: May 7, 2008

Related U.S. Application Data
(60) Provisional application No. 60/928,191, filed on May 8, 2007.

(51) Int. Cl. G06Q 99/00

(52) U.S. Cl. 705/4

(57) ABSTRACT

This is a business method for concrete coverage insurance and warranty or service contracts for home or business owners calculated by figuring the square footage of an area. The premium is figured by demographics with deductibles in place for high or low loss. Policy duration will be determined by experience of loss, but for the time being, will last for five (5) years and will be transferable. This is possible using all the technology an insurance company has to offer in the industry today with inspections on an annual basis. This will be coverage that is not now written by any company. It is a valuable business asset to a concrete company in the business of repair and new and replacement concrete. The trained inspector will catch problems before they become major structural problems. At the same time, the company will be training property owners on loss prevention and maintaining their concrete. This business method of calculating a premium with fixed deductibles will leave a customer knowing his costs and will show how insurance companies can figure premiums.

### BACKGROUND

This business method relates to concrete. Currently, concrete is only covered by insurance when it is damaged under casualty. My method will provide a homeowner or business (hereafter, referred to as customer) with complete insurance or warranty coverage on their concrete. Some Insurance Companies who do not carry complete insurance coverage on concrete caused by earth movement are: American Family, Allstate, Travelers, State Farm and Farmers Insurance.

There are service contracts for Vehicle U.S. Pat. No. 6,186,793 and U.S. Pat. No. 5,855,005 for casualty premiums, but these offer nothing in respect to coverage on concrete either by service contract or insurance.

This business method and software computation will benefit all customers with preventive maintenance, training and education in the field of concrete and structural integrity relating to their property. Steel piering of structures, underpinning and void filling of concrete has made insurance possible in the field of concrete.

The premium can be figured on a square foot basis. A property owner or insurance company can compute their premium with this method. Concrete coverage is needed to set the standard for replacement, repair and maintenance of concrete.

### SUMMARY

This business method is needed for risk-distribution of concrete repairs that are very expensive to the customer who is left with structural damage.

### DESCRIPTION

The premium will be established for each potential customer by measuring all areas of concrete, asphalt, brick, stucco, block and stone. The square footage will be multiplied by ten cents ($0.10). For example, a driveway is 19′×34′ which equals 646 square feet, a sidewalk is 4′×10′ which equals 40 square feet, the foundation is 60 square feet of wall×8′ high which equals 480 square feet, a basement floor is 20′×20′ which equals 400 square feet, and stucco siding is 8′×20′ which equals 160 square feet. This totals 1,726 square feet multiplied by $0.10 which equals a yearly premium of $172.60. The homeowner that decides at the time of the premium evaluation that he or she does not want to include some of the existing problems will be charged a higher premium by multiplying the total square footage of those areas by fifteen cents ($0.15) per square foot. This is because problems like poor drainage and concrete voids will only worsen leading to structural damage if they are not addressed sooner rather than later.

There will be a different deductible for each type of work to be done. For example, if the customer only needs pier work done and has to have three (3) piers installed at $400.00 each, then the deductible or cost to the customer would be $1,200.00 to have the work done. If the customer wants to have the driveway replaced as shown above, the deductible would be $4.75 per square foot multiplied by 646 square feet which equals $3,068.50 for a new driveway.

The deductible amount that each customer will be expected to pay when they have work done will vary demographically from area to area even within the same city because some structures are built on a hillside and others may have been built on loose fill materials which were not compacted properly to begin with. A deductible will be in the lower rate for areas designated as more stable and at a higher rate for areas built on soils not compacted properly or built on a hillside.

An assessment will be done on each property to address areas of concern, such as, the extent of cracking in the concrete, voids in the concrete and the settlement of the concrete. A measurement will be taken on their foundation using a transit or Total Station so that the homeowner or contractor doing the work knows exactly what has changed from one year to the next. This will be done on a yearly basis or sooner at the customer's request. This is a free service for customers when they first sign up and for every year they continue to pay their premium.

The description above contains much specificity. These should not be construed as limiting the scope of my business method, but merely provide some preferred ways of handling this method. The cost will vary from demographic area to area, according to labor and experience rating. For example, in Texas, a deductible on premiums could be lower than in New York.

The scope of my method patent should be determined by the appended claims, rather than by the examples given.

I. To provide a business method of insuring warranty and service contracts on concrete, asphalt, brick, stucco, block and stone.

II. Establish a premium by demographic areas. Different regions of the country will vary in the types of settlement problem prone to that area.

III. Early detection of problems with regard to steel piering, slab jacking and void filling will be a key factor in reducing overall costs.
